(19) United States
(12) Patent Application Publication
(10) Pub. No.: US 2020/0126548 A1
(43) Pub. Date: Apr. 23, 2020

(54) ELECTRONIC DEVICE AND CONTROLLING METHOD OF ELECTRONIC DEVICE

(71) Applicant: Samsung Electronics Co., Ltd., Suwon-si (KR)

(72) Inventors: Chanwoo KIM, Suwon-si (KR); Kyungmin LEE, Suwon-si (KR)

(21) Appl. No.: 16/601,940

(22) Filed: Oct. 15, 2019

(30) Foreign Application Priority Data
Oct. 17, 2018 (KR) 10-2018-0123974

(51) Int. Cl. G10L 15/22; G10L 15/16; G10L 15/02

(52) U.S. Cl. CPC G10L 15/22; G10L 15/16; G10L 2015/025; G10L 2015/223; G10L 15/02

(57) ABSTRACT

An electronic device to be controlled through speech recognition and a controlling method thereof are provided. The electronic device includes at least one processor configured for, based on a user speech being input through a microphone, identifying a grapheme sequence corresponding to the input user speech, obtaining a command sequence from the identified grapheme sequence based on an edit distance between each of a plurality of commands that are included in a command dictionary that is stored in the memory and are related to control of the electronic device and the identified grapheme sequence, mapping the obtained command sequence to one of a plurality of control commands to control an operation of the electronic device, and controlling an operation of the electronic device based on the mapped control command.

### CROSS-REFERENCE TO RELATED APPLICATION(S)

This application is based on and claims priority under 35 U.S.C. § 119(a) of a Korean patent application number 10-2018-0123974, filed on Oct. 17, 2018, in the Korean Intellectual Property Office, the disclosure of which is incorporated by reference herein in its entirety.

### BACKGROUND

### Field

The disclosure relates to an electronic device and a controlling method thereof. More particularly, the disclosure relates to an electronic device capable of controlling through a speech command, and a controlling method thereof.

### Description of Related Art

In the field of speech recognition, the process of recognizing a user's speech and the understanding of the language are generally made through a server that is connected to an electronic device. However, in the case of speech recognition made through a server, there is a problem that not only latency may occur, but also when the electronic device is in an environment that cannot connect to the server, speech recognition may not be performed.

These days, on-device speech recognition technology attracts an attention. However, when implementing the speech recognition technology in an on-device manner, there is a task to be solved to minimize the size of a speech recognition system while effectively processing user speeches that are input with various languages, pronunciations, and expressions.

Accordingly, there is a need for a technique that may minimize the size of a speech recognition system while implementing speech recognition technology in an on-device manner.

The above information is presented as background information only, and to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages, and to provide at least the advantages described below. Accordingly, an aspect of the disclosure is to provide an electronic device capable of minimizing a size of a speech recognition system while implementing the speech recognition technology using on-device method, and a controlling method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a microphone, a memory including at least one instruction, and at least one processor connected to the microphone and the memory to control the electronic device.

In accordance with another aspect of the disclosure, the processor may, based on a user speech being input through the microphone, identify a grapheme sequence corresponding to the input user speech, obtain a command sequence from the identified grapheme sequence based on an edit distance between each of a plurality of commands that are included in a command dictionary that is stored in the memory and are related to control of the electronic device and the identified grapheme sequence, map the obtained command sequence to one of a plurality of control commands to control an operation of the electronic device, and control an operation of the electronic device based on the mapped control command.

In accordance with another aspect of the disclosure, the memory may include software in which an end-to-end speech recognition model is implemented, and the at least one processor may execute software in which the end-to-end speech recognition model is implemented, and identify the grapheme sequence by inputting, to the end-to-end speech recognition model, a user speech that is input through the microphone.

In accordance with another aspect of the disclosure, the memory may include software in which an artificial neural network model is implemented, and the at least one processor may execute the software in which the artificial neural network model is implemented, and input the obtained command sequence to the artificial neural network model and map to at least one of the plurality of control commands.

In accordance with another aspect of the disclosure, at least one of the end-to-end speech recognition model or the artificial neural network model may include a recurrent neural network (RNN).

In accordance with another aspect of the disclosure, the at least one processor may jointly train an entire pipeline of the end-to-end speech recognition model and the artificial neural network model.

In accordance with another aspect of the disclosure, the edit distance may be a minimum number of removal, insertion, and substitution of a letter that are required to convert the identified grapheme sequence to each of the plurality of commands, and the at least one processor may obtain, from the identified grapheme sequence, a command sequence that is within a predetermined edit distance with the identified grapheme sequence among the plurality of commands.

In accordance with another aspect of the disclosure, the plurality of commands may be related to a type of the electronic device and a function included in the electronic device.

In accordance with another aspect of the disclosure, a controlling method of an electronic device is provided. The controlling method includes, based on a user speech being input through a microphone, identifying a grapheme sequence corresponding to the input user speech, obtaining a command sequence from the identified grapheme sequence based on an edit distance between each of a plurality of commands that are included in a command dictionary that is stored in the memory and are related to control of the electronic device and the identified grapheme sequence, mapping the obtained command sequence to one of a plurality of control commands to control an operation of the electronic device, and controlling an operation of the electronic device based on the mapped control command.

In accordance with another aspect of the disclosure, the identifying of the grapheme sequence may include inputting, to the end-to-end speech recognition model, a user speech that is input through the microphone.

In accordance with another aspect of the disclosure, the mapping of the obtained command sequence may include inputting the obtained command sequence to the artificial neural network model and mapping to at least one of the plurality of control commands.

In accordance with another aspect of the disclosure, the least one of the end-to-end speech recognition model or the artificial neural network model may include a recurrent neural network (RNN).

In accordance with another aspect of the disclosure, the controlling method may further include jointly training an entire pipeline of the end-to-end speech recognition model and the artificial neural network model.

In accordance with another aspect of the disclosure, the edit distance may be a minimum number of removal, insertion, and substitution of a letter that are required to convert the identified grapheme sequence to each of the plurality of commands, and the obtaining of the command sequence may include obtaining, from the identified grapheme sequence, a command sequence that is within a predetermined edit distance with the identified grapheme sequence among the plurality of commands.

In accordance with another aspect of the disclosure, the plurality of commands may be related to a type of electronic device and a function included in the electronic device.

In accordance with another aspect of the disclosure, a computer readable recordable medium is provided. The computer readable recordable medium includes a program for executing a controlling method of an electronic device, wherein the controlling method of the electronic device includes, based on a user speech being input through a microphone, identifying a grapheme sequence corresponding to the input user speech, obtaining a command sequence from the identified grapheme sequence based on an edit distance between each of a plurality of commands that are included in a command dictionary that is stored in the memory and are related to control of the electronic device and the identified grapheme sequence, mapping the obtained command sequence to one of a plurality of control commands to control an operation of the electronic device, and controlling an operation of the electronic device based on the mapped control command.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a control process of an electronic device according to an embodiment of the disclosure;

FIG. 2 is a block diagram illustrating a configuration of an electronic device according to an embodiment of the disclosure;

FIG. 3 is a block diagram illustrating a configuration of an end-to-end speech recognition model for identifying a grapheme sequence according to an embodiment of the disclosure;

FIGS. 4A and 4B are views illustrating a command dictionary and a plurality of commands included in the command dictionary according to various embodiments of the disclosure;

FIGS. 5A and 5B are block diagrams illustrating a configuration of an artificial neural network model for mapping between a command sequence and a plurality of control commands according to various embodiments of the disclosure; and

FIG. 6 is a flowchart to describe a controlling method of an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used the following description and claims are not limited to the bibliographical meanings, but are merely used to enable a clear and consistent understanding of the disclosure. Accordingly, it should be apparent to those skilled in the art that the following description of various embodiments of the disclosure is provided for illustration purpose only, and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this specification, the expressions “have,” “may have,” “include,” or “may include” or the like, represent presence of a corresponding feature (for example: components such as numbers, functions, operations, or parts) and does not exclude the presence of additional feature.

In this document, the expressions “A or B,” “at least one of A and/or B,” or “one or more of A and/or B,” and the like include all possible combinations of the listed items. For example, “A or B,” “at least one of A and B,” or “at least one of A or B” includes (1) at least one A, (2) at least one B, (3) at least one A and at least one B all together.

As used herein, the terms “first,” “second,” or the like, may denote various components, regardless of order and/or importance, and may be used to distinguish one component from another, and does not limit the components.

If it is described that a certain element (e.g., first element) is “operatively or communicatively coupled with/to” or is “connected to” another element (e.g., second element), it should be understood that the certain element may be connected to the other element directly or through still another element (e.g., third element). On the other hand, if it is described that a certain element (e.g., first element) is “directly coupled to” or “directly connected to” another element (e.g., second element), it may be understood that there is no element (e.g., third element) between the certain element and the another element.

Also, the expression “configured to” used in the disclosure may be interchangeably used with other expressions such as “suitable for,” “having the capacity to,” “designed to,” “adapted to,” “made to,” and “capable of,” depending on cases. The term “configured to” does not necessarily mean that a device is “specifically designed to” in terms of hardware.

Instead, under some circumstances, the expression “a device configured to” may mean that the device “is capable of” performing an operation together with another device or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

The term such as “module,” “unit,” “part”, and so on is used to refer to an element that performs at least one function or operation, and such element may be implemented as hardware or software, or a combination of hardware and software. Further, except for when each of a plurality of “modules”, “units”, “parts”, and the like needs to be realized in an individual hardware, the components may be integrated in at least one module or chip and be realized in at least one processor (not shown).

The disclosure will be described in greater detail below with reference to the accompanying drawings to enable those skilled in the art to work the t disclosure with ease. However, the disclosure may be implemented as several different forms and not to be limited to any of specific examples described herein. Further, in order to clearly describe the disclosure in the drawings, portions irrelevant to the description may be omitted, and throughout the description, the like elements are given the similar reference numerals.

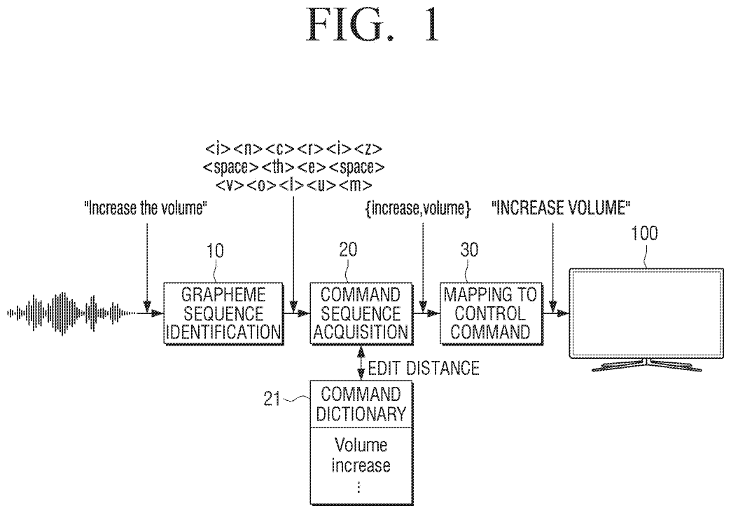

FIG. 1 is a block diagram illustrating a control process of an electronic device according to an embodiment of the disclosure.

Referring to FIG. 1, when a user speech is input to an electronic device 100 according to an embodiment, the electronic device 100 identifies a grapheme sequence corresponding to the inputted user speech. To do so, a grapheme sequence can be identified at module 10, and a command sequence can be acquired at module 20 with the assistance of a command dictionary module 21. The command sequence can then be mapped to a control command at module 30 and provided to the device 100.

The grapheme means an individual letter or a group of letters indicating one phoneme. For example, “spoon” includes graphemes such as <s>, <p>, <oo>, and <n>. Hereinafter, each grapheme is represented in < >.

For example, when a user speech such as “increase the volume” is input, the electronic device 100 may identify grapheme sequences such as <i><n><c><r><i><z><space><th><u><space><v><o><l><u><m> as the grapheme corresponding to the input user speech. Here, <space> represents a space.

When the grapheme sequence corresponding to the user speech is identified, the electronic device 100 obtains a command sequence from the identified grapheme sequence based on an edit distance between each of the plurality of commands that are included in a command dictionary stored in the memory and are related to control of the electronic device 100 and the identified grapheme sequence.

Specifically, the electronic device 100 may obtain, from the identified grapheme sequence, a command sequence that is within a predetermined edit distance with the identified grapheme sequence, among a plurality of commands included in a command dictionary.

The plurality of commands refers to commands related to a type and a function of the electronic device 100, and the edit distance means the minimum number of removal, insertion, and substitution of the letters required to convert the identified grapheme sequence into each of the plurality of commands.

Hereinbelow, an example is described that grapheme sequence such as <i><n><c><r><i><z><space><th><u><space><v><o><l><u><m> is identified, a plurality of commands included in the command dictionary are “increase” and “volume”, predetermined edit distance is 3, and a plurality of control commands to control an operation of the electronic device 100 is “increase the volume.”

Specifically, when <i> is substituted with <ea>, and <z> is substituted with <se> from <i><n><c><r><i><z>, <i><n><c><r><i><z> is converted to <i><n><c><r><ea><se>. Here, the minimum number of removal, insertion, and substitution of the letter that is required to convert <i><n><c><r><i><z> to <i><n><c><r><ea><se> is two and thus, the edit distance becomes 2.

When <e> is added to <v><o><l><u><m>, it is converted to <v><o><l><u><m><e>. Here, the minimum number of removal, insertion, and substitution of the letter that is required to convert <v><o><1><u><m> to <v><o><l><u><m><e> is one and thus, the edit distance becomes 1.

In the case of <th><u>, it can be easily understood that <th><u> may not be converted to <i><n><c><r><ea><se> and <v><o><l><u><m><e> through removal, insertion, and substitution less than or equal to three times.

Through the above process, a command sequence such as {increase, volume} is obtained from the grapheme sequence like <i><n><c><r><i><_{z}><space><th><ᵤ><space><ᵥ><o><l><ᵤ><m>.

When the command sequence is obtained, the obtained command sequence is mapped to one of a plurality of control commands for controlling an operation of the electronic device 100. For example, a command sequence such as {increase, volume} may be mapped to a control command of “increase the volume” of the plurality of control commands to control the operation of the electronic device 100.

If the obtained command sequence is mapped to one of the plurality of control commands, the electronic device 100 controls the operation of the electronic device 100 based on the mapped control command. For example, if the command sequence is mapped to a control command “increase the volume” among the plurality of control commands, the electronic device 100 may increase the volume of the electronic device 100 based on the mapped control command.

A type of the electronic device 100 according to various embodiments is not restricted, once the type is within the scope of achieving the objectives of the disclosure. For example, the electronic device 100 may include, but is not limited to, a smartphone, a tablet PC, a camera, an air conditioner, a TV, a washing machine, an air cleaner, a cleaner, a radio, a fan, a light, a navigation of a vehicle, a car audio a wearable device, or the like.

In addition, as the type of the electronic device 100 may vary according to various embodiments of the disclosure, the control command of the electronic device 100 as described above may be different in accordance with the type of the electronic device 100 and a function included in the electronic device 100. A plurality of commands included in the command dictionary may also vary depending on the type and function of the electronic device 100.

Hereinbelow, various embodiments of the disclosure will be described in greater detail based on the specific configurations of the electronic device 100.

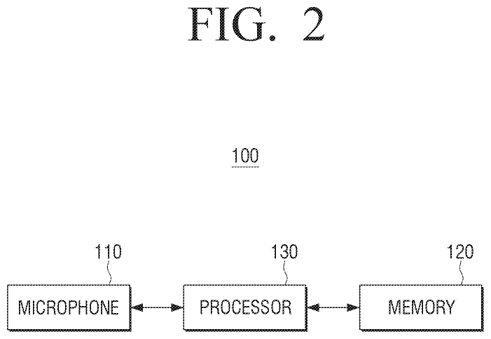

FIG. 2 is a block diagram illustrating a configuration of an electronic device according to an embodiment of the disclosure.

Referring to FIG. 2, the electronic device 100 according to an embodiment includes a microphone 110, a memory 120, and at least one processor 130.

The microphone 110 may receive a user speech to control an operation of the electronic device 100. To be specific, the microphone 110 may play a role to convert an acoustic signal according to a user speech into an electrical signal.

In various embodiments, the microphone 110 may receive a user speech corresponding to a command to control an operation of the electronic device 100.

The memory 120 may store at least one command for the electronic device 100. In addition, the memory 120 may store an operating system (O/S) for driving the electronic device 100. The memory 120 may store various software programs or applications for operating the electronic device 100 in accordance with various embodiments of the disclosure. The memory 120 may include a semiconductor memory such as a flash memory, a magnetic storage medium such as a hard disk, or the like.

Specifically, the memory 120 may store various software modules to operate the electronic device 100 according to the various embodiments, and the processor 130 may control an operation of the electronic device 100 by executing various software modules stored in the memory 120.

In particular, in various embodiments of the disclosure, an artificial intelligence (AI) model such as an end-to-end speech recognition model and an artificial neural network model, as described below, may be implemented with software and stored in the memory 120, and the processor 130 may execute software stored in the memory 120 to perform the identification process of the grapheme sequence and the mapping process between the command sequence and the control command according to the disclosure.

In addition, the memory 120 may store a command dictionary. The command dictionary may include a plurality of commands related to the control of the electronic device 100. Specifically, the command dictionary stored in the memory 120 may include a plurality of commands related to the type and function of the electronic device 100.

The processor 130 controls overall operation of the electronic device 100. To be specific, the processor 130 may be connected to the configuration of the electronic device 100 including the microphone 110 and the memory 120 and control overall operation of the electronic device 100.

The processor 130 may be implemented in various ways. For example, the processor 130 may be implemented with at least one of an application specific integrated circuit (ASIC), an embedded processor, a microprocessor, a hardware control logic, a hardware finite state machine (FSM), and a digital signal processor (DSP).

The processor 130 may include a read-only memory (ROM), random access memory (RAM), graphic processing unit (GPU), central processing unit (CPU), and a bus, and the ROM, RAM, GPU, CPU, or the like, may be interconnected through the bus.

In various embodiments according to the disclosure, the processor 130 controls overall operations including a process of identification of a grapheme sequence corresponding to a user speech, a process of obtaining the command sequence, a mapping process between the command sequence and the control command and the control process of the electronic device 100 based on the control command.

To be specific, when the user speech is input through the microphone 110, the processor 130 identifies the grapheme sequence corresponding to the input user speech.

As the example of FIG. 1, when the user speech such as “increase the volume” is input, the processor 130 may identify the grapheme sequence like <i><n><c><r><i><z><space><th><u><space><v><o><l><u><m> as the grapheme sequence corresponding to the user speech.

As a still another example, in Korean language, if the user speech “ [symbol] [symbol] (make sound loud)” is input, the processor 130 may identify the grapheme sequence [symbol] space [symbol] space [symbol] [symbol] space [symbol] as the grapheme sequence corresponding to the input user speech. Here, [symbol] indicates final consonant of [symbol] .

In general, the related-art speech recognition system includes an acoustic model (AM) for extracting an acoustic feature and predicting a sub-word unit such as a phoneme, a pronunciation model (PM) for mapping the phoneme sequence with a word, and a language model (LM) for designating probability to a word sequence.

In the related-art speech recognition system, it is general that AM, PM, and LM are trained independently on different data sets. Recently, an end-to-end speech recognition model, which combines AM, PM, and LM components into a single neural network, has been developed.

According to the end-to-end speech recognition model, a separate pronunciation dictionary or a pronunciation lexicon for mapping a phoneme unit to a word it not necessary. In this regard, the speech recognition process may be simplified.

The end-to-end speech recognition model may also be applied in the disclosure. Specifically, according to an embodiment, the memory 120 may include software in which the end-to-end speech recognition model is implemented. In addition, the processor 130 may execute the software stored in the memory 120 and input a user speech input through the microphone 110 to the end-to-end speech recognition model to identify the grapheme sequence.

The end-to-end speech recognition model may be implemented in software and stored in the memory 120. In addition, the end-to-end speech recognition model may be implemented in a dedicated chip capable of performing an algorithm of an end-to-end speech recognition model and included in the processor 130.

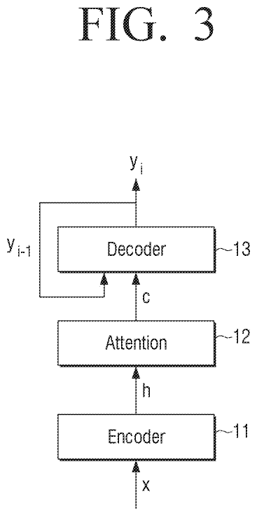

Further details of the end-to-end speech recognition model will be described with respect to FIG. 3.

When the grapheme sequence corresponding to the user speech is identified, the electronic device 100 obtains the command sequence from the identified grapheme sequence based on the edit distance between each of a plurality of commands that are included in the command dictionary stored in the memory 120 and are related to control of the electronic device 100 and the identified grapheme sequence.

Specifically, the electronic device 100 may obtain a command sequence that is within the predetermined edit distance with the identified grapheme sequence among a plurality of commands included in the command dictionary.

A plurality of commands means a command that is related to the type and function of the electronic device 100, and the edit distance means the minimum number of removal, insertion, and substitution required to convert the identified grapheme sequence into each of the plurality of commands. Further, the preset edit distance may be set by the processor 130 and may be set by the user.

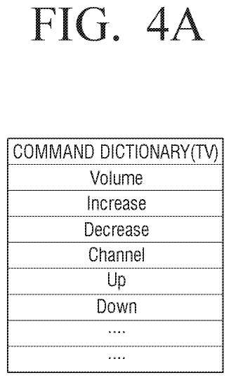

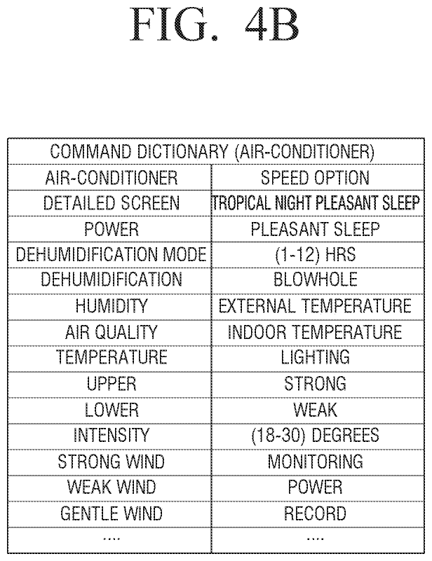

A specific example of a plurality of commands will be described with respect to FIGS. 4A and 4B.

As the example of FIG. 1, the edit distance according to conversion of <i><n><c><r><i><z> to <i><n><c><r><ea><se> is 2, and the edit distance according to conversion of <v><o><l><u><m> into <v><o><l><u><m><e> is 1. In this case, when the predetermined edit distance is 3, the command sequence as {increase, volume} is obtained from the grapheme sequence such as <i><n><c><r><i><z><space><th><u><space><v><o><l><u><m>.

When the user speech such as “increase the volume” is input, a grapheme sequence that is different from the above example may be identified. For example, the user speech as “increase the volume” is input, the grapheme sequence as <i><n><c><r><i><se><space><th><u><space><v><ow><l><u><m> may be identified. However, in this case as well, the edit distance according to conversion of <i><n><c><r><i><se> into <i><n><c><r><ea><se> is 1, and the edit distance according to conversion of <v><ow><l><u><m> to <v><o><l><u><m><e> is 2, and the command sequence such as {increase, volume} is obtained.

According to a still another embodiment, the grapheme sequence such as [symbol] space [symbol] space [symbol] [symbol] space [symbol] may be identified, a predetermined edit distance is 3, and the command dictionary includes commands such as “sound” and “size”.

In this case, when [symbol] of [symbol] is substituted with [symbol] , it is substituted to [symbol] and the minimum number of removal, insertion, and substitution of a letter required to convert [symbol] to [symbol] is one time and thus, the edit distance is 1.

In [symbol] , when [symbol] is substituted with [symbol] , it is substituted to [symbol] , and the minimum number of removal, insertion, and substitution required to substitute [symbol] to [symbol] is one time and thus, the edit distance is 1.

It is assumed that the remaining identified graphemes may not be converted to a plurality of commands included in the command dictionary through removal, insertion, and substitution that are three times or less.

Through the above process, the command sequence {sound, loud} is obtained from the grapheme sequence such as [symbol] space [symbol] space [symbol] [symbol] space [symbol] .

Upon obtaining the command sequence from the identified grapheme sequence, the processor 130 maps the obtained command sequence to one of a plurality of control commands for controlling an operation of the electronic device 100.

As the example of FIG. 1, the command sequence such as {increase, volume} may be mapped to a control command for an operation of “volume increase” among the plurality of control commands to control an operation of the electronic device 100.

As another example, the command sequence such as {sound, loud} also may be mapped to a control command about “increase volume” among a plurality of control commands to control an operation of the electronic device 100.

In the above, it is assumed that the command sequence is mapped to one of a plurality of control commands for controlling the operation of the electronic device 100, but this is merely for convenience of description, and is not limiting the case where the command sequence is mapped to two or more control commands.

According to a still another embodiment, when the command sequence such as {volume, Increase, Channel, Up} is obtained, the command sequence may be mapped to two control commands such as “increase volume” and “increase channel” and accordingly, the operation of “increase volume” and “increase channel” may be sequentially performed.

The mapping process between the command sequence and a plurality of control commands may be done according to a predetermined rule, or may be done through learning of an artificial neural network model.

That is, according to an embodiment, the memory 120 may include software in which an artificial neural network model for mapping between a command sequence and a plurality of control commands is implemented. In addition, the processor 130 may execute software stored in the memory 120 and input a command sequence into the artificial neural network model to map to one of the plurality of control commands.

The artificial neural network model may be implemented as software and stored in the memory 120, or implemented as an exclusive chip for performing algorithm of the artificial neural network model and may be included in the processor 130.

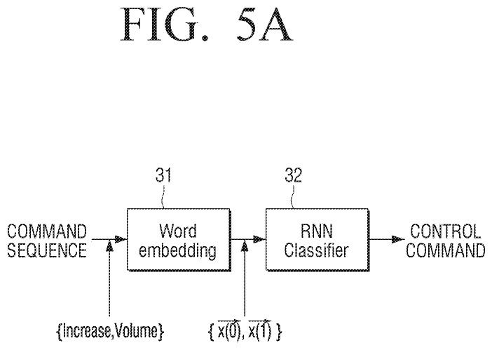

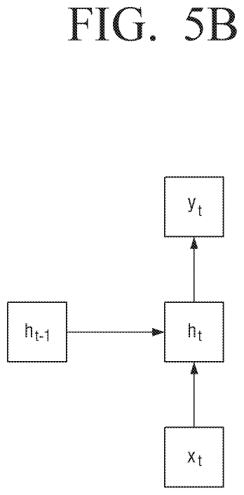

A further specific description about the artificial neural network model will be described in FIGS. 5A and 5B.

If the obtained command sequence is mapped to one of a plurality of control commands, the electronic device 100 controls the operation of the electronic device 100 based on the mapped control command. For example, as is the two examples described above, when the command sequence is mapped to a control command “increase volume” among the plurality of control commands, the electronic device 100 may increase the volume of the electronic device 100 based on the mapped control command.

Though not illustrated in FIG. 2, the electronic device 100 according to an embodiment may further include an outputter (not shown). The outputter (not shown) may output various functions that the electronic device 100 may perform. The outputter (not shown) may include a display, a speaker, a vibration device, or the like.

In the control process according to the disclosure, if the control of the electronic device 100 is performed smoothly as the user intended with the speech, the user confirms that the operation is performed to recognize that control of the electronic device 100 is performed smoothly.

However, it may happen that the control of the electronic device 100 is not smoothly performed unlike the intention of the user's speech, as in a case where the user's speech command is made of a very abstract word. In this case, there is a need to provide a notification to the user to make the user give a user speech again.

According to an embodiment, even if the user speech is input, but the control for the operation of the electronic device 100 is not performed for a predetermined time, the processor 130 may control an outputter (not shown) to provide the user with a notification.

For example, the processor 130 may control the display to output a visual image indicating that smooth control has not been performed, may control the speaker to output a speech indicating that smooth control has not been performed, or control a vibrating device to convey vibration indicating that smooth control has not been performed.

In describing various embodiments, it has been described as an example that the grapheme sequence corresponding to the user's speech is identified, but the embodiment is not necessarily limited thereto.

That is, within the scope of achieving the objectives of the disclosure, the disclosure may be implemented with various sub-words as a unit of speech recognition, in addition to the grapheme. Here a sub-word refers to various sub-components that make up a word, such as a grapheme or word piece.

According to still another embodiment, the processor 130 may identify a still another sub-word corresponding to the input user speech, for example, sequence of a word piece. The processor 130 may obtain a command sequence from the sequence of identified word pieces, map the command sequence to one of the plurality of control commands, and control operation of the electronic device based on the mapped control command.

Here, a word piece is a sub-word that allows a limited number of words to represent all words in the corresponding language, and an example of a specific word piece may vary according to a learning algorithm for obtaining a word piece and a type of word with a high frequency of use in the corresponding language.

For example, in English, the word “over” is frequently used, and the word itself is one word piece, but the word “Jet” is not frequently used, and thus may be identified by word pieces of “J” and “et.” For example, when learning a word piece using an algorithm such as, for example, a Byte-Pair Encoding (BPE), five thousand to ten thousand word pieces may be obtained.

It has been described that the user speech is input in English or Korean, but the user speech may be input in various languages. In addition, the unit of the sub-word identified according to the disclosure, an end-to-end speech recognition model for identifying a sub-word, or an artificial neural network model for mapping between a command sequence and a plurality of control commands may be variously changed within the scope to achieve the objective of the disclosure according to which language the user speech is input.

According to the various embodiments, the size of the speech recognition system may be minimized while implementing the speech recognition technology in on-device method.

Specifically, according to the disclosure, the memory 120 usage may be minimized by using the end-to-end speech recognition model and a command dictionary that combine the components of AM, PM, and LM into a single neural network. Accordingly, the problem of unit price increase due to high memory 120 usage may be solved, and a user may be free from the effort to implement LM and PM differently for each device.

By utilizing the artificial neural network model for mapping between a command sequence and a plurality of control commands, more flexible processing of user commands is possible. Furthermore, by conducting joint training for the end-to-end speech recognition model for identifying the grapheme sequence and the entire pipeline of the artificial neural network model for mapping between the command sequence and the plurality of control commands, more flexible user command processing is available.

FIG. 3 is a block diagram illustrating a configuration of an end-to-end speech recognition model for identifying a grapheme sequence according to an embodiment of the disclosure.

As described above, recently, the end-to-end speech recognition model which combines the elements of the AM, PM, and LM with the single neural network has been developed, and the end-to-end speech recognition model may be applicable to this disclosure.

To be specific, according to an embodiment, the processor 130 may identify the grapheme sequence by inputting the user speech that is input through the microphone 110 to the end-to-end speech recognition model.

FIG. 3 illustrates a configuration of the attention based model among the end-to-end speech recognition model according to an embodiment of the disclosure.

Referring to FIG. 3, the attention based model may include an encoder 11, an attention module 12, and a decoder 13. The encoder 11 and the decoder 13 may be implemented with recurrent neural network (RNN).

The encoder 11 receives a user speech x and maps the acoustic feature of x to a higher order feature representation h. When the high-dimensional acoustic feature h is delivered to the attention module 12, the attention module 12 may determine which part of the acoustic feature x should be considered important in order to predict the output y, and transmit the attention context c to the decoder 13. When the attention turntext c is transmitted to the decoder 13, the decoder 13 receives the attention context c and yi-1 corresponding to the embedding of the previous prediction, generates a probability distribution P and predicts the output yi.

According to the end-to-end speech recognition model as described above, the end-to-end grapheme decoder with the user speech as an input value and the grapheme sequence corresponding to the user speech as an output value may be implemented. According to the size of the input data and training of the artificial neural network for the input data, a grapheme sequence which more accurately corresponds to the user speech may be identified.

The configuration of FIG. 3 is merely exemplary, and within the scope of achieving the objective of the disclosure, various types of end-to-end speech recognition model may be applied.

As described above, according to an embodiment, by using the command dictionary instead of a pronunciation dictionary and using the end-to-end speech recognition model which is a method to combine the elements of AM, PM, and LM with the single neural network, the use of memory 120 may be minimized.

FIGS. 4A and 4B are views illustrating a command dictionary and a plurality of commands included in the command dictionary according to various embodiments of the disclosure.

The command dictionary according to the disclosure is stored in the memory 120, and includes a plurality of commands. The plurality of commands is related to control of the electronic device 100. To be specific, a plurality of commands is related to a type of the electronic device 100 and a function included in the electronic device 100. That is, the plurality of commands may be different according to various types of the electronic device 100, and may be different according to a function of the electronic device 100 even for the electronic device 100 in the same type.

FIG. 4A is a view illustrating a plurality of commands included in the command dictionary with an example where the electronic device 100 is a TV according to an embodiment of the disclosure.

Referring to FIG. 4A, when the electronic device 100 is a TV, the command dictionary may include a plurality of commands such as “Volume”, “Increase”, “Decrease”, “Channel”, “Up”, and “Down”.

FIG. 4B is a view to specifically illustrate a plurality of commands included in the command dictionary with an example where the electronic device 100 is an air-conditioner according to an embodiment of the disclosure.

Referring to FIG. 4B, when the electronic device 100 is an air-conditioner, a plurality of commands such as “air-conditioner,” “detailed screen,” “power source” “dehumidification,” “humidity,” “temperature,” “upper portion,” “intensity,” “strong,” “weak,” “pleasant sleep,” “external temperature,” “power,” or the like, may be included.

The more the number of commands included in the command dictionary, the command sequence may be more easily obtained from the speech of the user, while the efficiency of the process of mapping the obtained command sequence to the plurality of control commands may decrease. In addition, the less the number of commands included in the command dictionary, it is difficult to easily obtain a command sequence from the user speech, but the obtained command sequence may be easily mapped to one of a plurality of control commands.

Therefore, the amount of the plurality of commands included in the command dictionary should be determined in comprehensive consideration of the number of the function of the electronic device 100 and the type of the electronic device 100, the specific artificial neural network model to implement the disclosure, and the efficiency in the entire control process according to the disclosure, or the like.

The plurality of commands included in the command dictionary may remain stored in the memory 120 at the time of launch of the electronic device 100 as they are, but are not necessarily limited thereto. That is, as the function of the electronic device 100 is updated after the launch, a command corresponding to the updated function may be added to the command dictionary.

A command corresponding to a specific function may be added to the command dictionary according to a user command. For example, there may be a case where a user makes a speech of “be quiet” to execute a mute function of a TV.

In this case, if “quiet” is not included in the command dictionary, even if the user speech of “be quiet” is input, the control of the operation of the electronic device 100 is not performed for a predetermined time. A notification may be given to a user through an outputter (not shown). In this case, the user may give another speech, or add a command “quiet” to the command dictionary.

FIGS. 5A and 5B are block diagrams illustrating a configuration of an artificial neural network model for mapping between a command sequence and a plurality of control commands according to various embodiments of the disclosure.

Referring to FIG. 5A, the artificial neural network model for mapping between the command sequence and the plurality of control commands may include a word embedding module 31 and an RNN classifier module 32.

Specifically, the command sequence may go through the word embedding process and be converted to the sequence of vector. Here, the word embedding means mapping a word to a point on a vector space.

For example, when the command sequence such as {increase, volume} that is obtained according to an embodiment goes through the word embedding process, the sequence may be converted to the sequence of the vector such as {\vec{x(o)}, \vec{x(1)}}.

There are a variety of ways to consider the meaning of the command when converting each command forming the command sequence into a vector through word embedding, and the relationship between the commands, or the like, the disclosure is not limited to a specific word embedding method.

When the command sequence is converted to the sequence of vector via the word embedding module 31, the sequence of vector may be classified through the RAW classifier 32, and accordingly, it may be mapped to one of the plurality of control commands to control an operation of the electronic device 100.

For example, when the sequence of vector such as {volume, loud}, {volume, increase}, {volume, very loud}, {volume, small} and {volume, decrease} is obtained via the word embedding module 31, the RNN Classifier 32 may classify {volume, loud}, {volume, increase} into the same one vector dimension.

The RNN classifier 32 may classify {volume, very loud} to a still another vector dimension that is similar as the above, but is related to more volume increase, and may classify {volume, small}, {volume, decrease} into one vector dimension that is different from the above two examples.

Each of the above classification may be mapped to each of the control commands such as “increase volume by one step,” “increase volume by three steps,” and “decrease volume by one step” among a plurality of control commands to control an operation of the electronic device 100.

The RNN is a type of the artificial neural network having a circulation structure, and is a model that is suitable for processing of data that is sequentially configured such as a speech or a letter.

Referring to FIG. 5B, the basic configuration of the RNN, xₜ is the input value at time step t, hₜ is the hidden state at time step t, and is calculated by the hidden state value of the previous time step hₜ₋₁ and the input value of the current time step. The yₜ is the output value at time step t. That is, according to the artificial neural network as shown in FIG. 5B, the past data may affect the current output.

According to one embodiment of the disclosure as described above, a more flexible user command processing is possible by applying the artificial neural network model for mapping between the command sequence and a plurality of control commands. However, the configuration of the artificial neural network as described above is exemplary, and various artificial neural network structures such as convolutional neural networks (CNN) may be applied if within the scope that may achieve the objective of the disclosure.

It has been described that the end-to-end speech recognition model for identification of the grapheme sequence and the artificial neural network model for mapping the command sequence to a plurality of control commands are implemented as each independent model.

According to a still another embodiment, the end-to-end speech recognition model for identification of the grapheme sequence, and the entire pipeline of the artificial neural network for mapping between the command sequence and the plurality of control commands may be jointly trained.

That is, the entire pipeline of the end-to-end speech recognition model and the artificial neural network model may be trained in an end-to-end manner like as training one model with the user speech as the input value and the control command corresponding to the user speech as the output value.

The intension of the user of the electronic device 100 of the user speech is to perform an operation of the electronic device corresponding to the user speech command, and thus, when training the pipeline by end-to-end with the user speech as an input value and the control command corresponding to the user speech as an output value, more accurate and flexible user command processing is available.

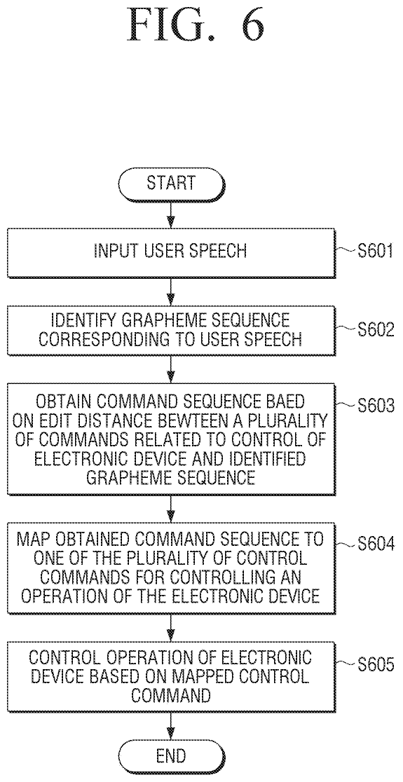

FIG. 6 is a flowchart to describe a controlling method of an electronic device according to an embodiment of the disclosure.

Referring to FIG. 6, when a user speech is input through a microphone in operation S601, the electronic device identifies a grapheme sequence corresponding to an input user speech in operation S602.

To be specific, the electronic device may identify the grapheme sequence by inputting the user speech that is input through a microphone, to the end-to-end speech recognition model.

When the grapheme sequence is identified, the electronic device obtains the commands sequence from the identified grapheme sequence, based on the edit distance between each of the plurality of commands included in the command dictionary stored in the memory and are related to control the electronic device in operation S603.

Here, the edit distance means the minimum number of removal, insertion, and substitution of the letters required to convert the identified grapheme sequence into each of the plurality of commands. The electronic device may obtain, from the identified grapheme sequence, a command sequence that is within a predetermined edit distance with the identified grapheme sequence of the plurality of commands.

When the command sequence is obtained, the obtained command sequence is mapped to one of the plurality of control commands to control an operation of the electronic device in operation S604.

Specifically, the electronic device may input the obtained command sequence to the artificial neural network model and map the command sequence to at least one of the plurality of control commands.

When the command sequence is mapped to one of the plurality of control commands, an operation of the electronic device is controlled based on the mapped control command in operation S605.

The at least one model of the end-to-end speech recognition model and the artificial neural network model as described above may include a recurrent neural network (RNN). According to one embodiment, the pipeline of the end-to-end speech recognition model and the artificial neural network model may be jointly trained.

According to various embodiments of the disclosure as described above, while implementing the speech recognition technology in an on-device manner, it is possible to minimize the size of the speech recognition system. Specifically, the memory usage may be minimized by utilizing an end-to-end speech recognition model and a command dictionary, and by using the artificial neural network model for mapping between the command sequence and a plurality of control commands, more flexible user command processing is possible.

The controlling method of the electronic device may be implemented with a program and provided to the electronic device. In particular, a program which includes a controlling method of the electronic device may be stored in a non-transitory computer readable medium and provided.

Specifically, in a computer-readable recording medium including a program for executing a control method of the electronic device, the controlling method of a user terminal includes, if a user speech is input through a microphone, identifying a grapheme sequence corresponding to the input user speech, based on the edit distance between each of a plurality of commands included in the command dictionary stored in memory and related to control of the electronic device and identified grapheme sequence, obtaining a command sequence from the identified grapheme sequence, mapping the obtained command sequence with one of a plurality of control commands for controlling the operation of the electronic device, and controlling the operation of the electronic device based on the mapped control command.

The non-transitory computer readable medium refers to a medium that stores data semi-permanently rather than storing data for a very short time, such as a register, a cache, a memory or etc., and is readable by an apparatus. In detail, the aforementioned various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

While the disclosure has been shown and described with reference to various embodiments thereof, it will be understood by those skilled in the art that various changes in form and detail may be made therein without departing from the spirit and scope of the disclosure as defined by the appended claims and their equivalents.

What is claimed is:

1. An electronic device comprising:
a microphone;
a memory including at least one instruction; and
at least one processor connected to the microphone and the memory to control the electronic device,
wherein the at least one processor is configured to:
based on a user speech being input through the microphone, identify a grapheme sequence corresponding to the input user speech,
obtain a command sequence from the identified grapheme sequence based on an edit distance between each of a plurality of commands that are included in a command dictionary that is stored in the memory and are related to control of the electronic device and the identified grapheme sequence,
map the obtained command sequence to one of a plurality of control commands to control an operation of the electronic device, and
control an operation of the electronic device based on the mapped control command.

2. The electronic device of claim 1,
wherein the memory comprises software in which an end-to-end speech recognition model is implemented, and
wherein the at least one processor is further configured to:
execute software in which the end-to-end speech recognition model is implemented, and
identify the grapheme sequence by inputting, to the end-to-end speech recognition model, a user speech that is input through the microphone.

3. The electronic device of claim 2,
wherein the memory comprises software in which an artificial neural network model is implemented, and
wherein the at least one processor is further configured to:
execute the software in which the artificial neural network model is implemented, and
input the obtained command sequence to the artificial neural network model and map to at least one of the plurality of control commands.

4. The electronic device of claim 3, where at least one of the end-to-end speech recognition model or the artificial neural network model comprises a recurrent neural network (RNN).

5. The electronic device of claim 3, wherein the at least one processor is further configured to jointly train an entire pipeline of the end-to-end speech recognition model and the artificial neural network model.

6. The electronic device of claim 1,
wherein the edit distance is a minimum number of removal, insertion, and substitution of a letter that are required to convert the identified grapheme sequence to each of the plurality of commands, and
wherein the at least one processor is further configured to obtain, from the identified grapheme sequence, a command sequence that is within a predetermined edit distance with the identified grapheme sequence among the plurality of commands.

7. The electronic device of claim 1, wherein the plurality of commands is related to a type of the electronic device and a function included in the electronic device.

8. A controlling method of an electronic device, the method comprising:
based on a user speech being input through a microphone, identifying a grapheme sequence corresponding to the input user speech;
obtaining a command sequence from the identified grapheme sequence based on an edit distance between each of a plurality of commands that are included in a command dictionary that is stored in the memory and are related to control of the electronic device and the identified grapheme sequence;
mapping the obtained command sequence to one of a plurality of control commands to control an operation of the electronic device; and
controlling an operation of the electronic device based on the mapped control command.

9. The controlling method of claim 8, wherein the identifying of the grapheme sequence comprises inputting, to the end-to-end speech recognition model, a user speech that is input through the microphone.

10. The controlling method of claim 9, wherein the mapping of the obtained command sequence comprises inputting the obtained command sequence to the artificial neural network model and mapping the obtained command sequence to at least one of the plurality of control commands.

11. The controlling method of claim 10, where at least one of the end-to-end speech recognition model or the artificial neural network model comprises a recurrent neural network (RNN).

12. The controlling method of claim 10, further comprising:
jointly training an entire pipeline of the end-to-end speech recognition model and the artificial neural network model.

13. The controlling method of claim 8,
wherein the edit distance is a minimum number of removal, insertion, and substitution of a letter that are required to convert the identified grapheme sequence to each of the plurality of commands, and
wherein the obtaining of the command sequence comprises obtaining, from the identified grapheme sequence, a command sequence that is within a predetermined edit distance with the identified grapheme sequence among the plurality of commands.

14. The controlling method of claim 8, wherein the plurality of commands is related to a type of the electronic device and a function included in the electronic device.

15. A non-transitory computer readable recordable medium including a program for executing a controlling method of an electronic device, wherein the controlling method of the electronic device comprises:
based on a user speech being input through a microphone, identifying a grapheme sequence corresponding to the input user speech;
obtaining a command sequence from the identified grapheme sequence based on an edit distance between each of a plurality of commands that are included in a command dictionary that is stored in the memory and are related to control of the electronic device and the identified grapheme sequence;
mapping the obtained command sequence to one of a plurality of control commands to control an operation of the electronic device; and
controlling an operation of the electronic device based on the mapped control command.
